(19) United States
(12) Patent Application Publication
(10) Pub. No.: US 2025/0114760 A1
(43) Pub. Date: Apr. 10, 2025

(54) BEAD DISPENSERS

(71) Applicants: James Patrick Finn, IV, Oregon, WI (US); Matthew Samuel Finn, Burnsville, MN (US)

(72) Inventors: James Patrick Finn, IV, Oregon, WI (US); Matthew Samuel Finn, Burnsville, MN (US)

(21) Appl. No.: 18/481,299

(22) Filed: Oct. 5, 2023

(51) Int. Cl. B01J 4/00

(52) U.S. Cl. CPC B01J 4/001; B01J 2219/00468

(57) ABSTRACT

This document provides bead dispensing devices that can be configured to mount onto a container (e.g., a test tube containing sterile beads) and allow for a set number of beads (e.g., glass beads) to be dispensed.

### BACKGROUND

### 1. Technical Field

This document relates to bead dispensers (e.g., glass bead dispensers) and methods and materials for dispensing beads.

### 2. Background Information

Often the first technique microbiologists learn is spreading bacteria on agar plates. There are two techniques for spreading bacteria. One technique uses a glass or metal rod shaped like a hockey stick. With this technique, the operator sterilizes the rod with flaming ethanol and gently spreads dispensed cell culture across the surface of the agar plate. The second technique is called the Copacabana method. For this method, the operator dispenses sterile glass beads onto an agar plate, and then gently agitates the plate to evenly disperse the cell culture across the surface of the plate. If done correctly, these techniques result in bacterial colony formation from single cells, also called Colony Forming Units (CFUs). CFUs are useful for several reasons including the construction of genetic manipulation libraries, DNA cloning, testing drug resistance, and detection of bacteria in various sample types like food and clinical samples.

There are several advantages for using the Copacabana method for spreading bacteria instead of glass or metal rods. First, the Copacabana method requires less technical skill from the operator. The use of rods sometimes results in damage to the agar plates, which smears the bacterial colonies and makes it difficult to accurately count CFUs. This possibility is drastically reduced when using the Copacabana method. Second, the Copacabana method uses pre-sterilized glass beads, eliminating the need for ethanol ignition for sterilization. Eliminating the need for ethanol ignition creates a safer environment, especially when the operator is a novice microbiologist.

### SUMMARY

One disadvantage to using glass beads is accurate dispersal of the beads onto an agar plate. The number of beads required to evenly distribute CFUs varies among different microorganisms, but once established, it can be difficult for the operator to dispense the correct number of beads for even CFU distribution. There are two methods for bead dispensing. One method is called the BARRY modification to the Copacabana method. The BARRY modification sterilizes small tubes containing the exact number of beads in each small tube. This removes the need to pour the correct number of beads onto an agar plate by hand but drastically increases bead preparation time. The second method is dispensing glass beads by hand from larger, sterilized vessels such as 13 mm by 100 mm and 18 mm by 150 mm test tubes. For this method, it is easy and efficient to prepare and sterilize a large number of glass beads, but this method makes it difficult to dispense the desired number of beads onto an agar plate. This is a major issue for two reasons. First, if not enough beads are dispensed onto the agar plate, then there will be uneven CFU distribution. Second, if too many beads are dispensed, then a high number of CFUs will be lost since bacteria will attach to the beads that are then disposed of. This major issue results in an inaccurate CFU calculation. For the Copacabana method to be most effective and efficient, the correct number of glass beads must be dispensed.

This document provides bead dispensing devices that can be configured to mount onto a container (e.g., a test tube containing sterile beads) and allow for a set number of beads (e.g., glass beads) to be dispensed. For example, a bead dispensing device provided herein can be configured to mount onto the open end of a test tube such as a 13 mm, 16 mm, 18 mm, or 25 mm test tube already containing beads (e.g., glass beads). In some cases, once mounted, the entire apparatus (e.g., bead dispensing device, container, and beads) can be sterilized, thereby providing an operator with the ability to dispense a set number of sterile beads. In operation, the operator can invert the apparatus so that the container aperture (e.g., the test tube aperture) with the mounted bead dispensing device is closest to an agar plate. This motion can move the beads toward the bead dispensing device such that beads enter the bead dispensing device. At this point, the operator can rotate the apparatus to dispense a set number of beads from the bead dispensing device into the agar plate.

In general, one aspect of this document features a bead dispenser, wherein the bead dispenser is adapted to mount onto a test tube containing beads of a uniform diameter and dispense a number of the beads from the test tube upon a single upright to inverted and rotated movement of the test tube containing the beads and the bead dispenser, wherein the number of the beads dispensed from each of a plurality of single upright to inverted and rotated movement cycles is the same. The bead dispenser can comprise a cap portion adapted to mount over a top portion of the test tube. The bead dispenser can comprise a bead channel defining a bead entry opening and a bead exit opening and a lumen extending from the bead entry opening to the bead exit opening. The diameter of the lumen can be 1 mm to 2 mm larger than the uniform diameter of the beads. The bead channel can extend away from the test tube in a first linear path, can curve, and can extend in a second linear path. The curve can be from 175 degrees to 180 degrees. The curve can be 180 degrees such that the first linear path and the second linear path are parallel. The bead channel can comprise a second curve after the second linear path and before the bead exit opening. The second curve can be from 80 degrees to 90 degrees. The second curve can be 90 degrees such that the bead exit opening is perpendicular to the second linear path. The bead dispenser can be detachable from the test tube. The bead dispenser can be made of a material comprising plastic. The uniform diameter of the beads can be from 3.8 mm to 4.2 mm (e.g., 3.8 mm, 3.9 mm, 4.0 mm, or 4.1 mm). The inner diameter of the cap portion can be adapted for a snug fit over the test tube. In some cases, that inner diameter can be about 17 mm to 18 mm (e.g., 18.29 mm) when the outer diameter of the test tube is 18 mm. In some cases, the outer diameter of the cap portion can be 20 mm to 21 mm when the outer diameter of the test tube is 18 mm.

In another aspect, this document features a method for dispensing beads from a test tube comprising a plurality of beads of a uniform diameter and a bead dispenser attached to a top of the test tube. The method comprises (a) inverting and rotating the test tube over a first target vessel, wherein a first number of the beads is dispensed to the first target vessel, and (b) inverting and rotating the test tube over a second target vessel, wherein a second number of the beads is dispensed to the second target vessel, wherein the first number and the second number are the same. The bead dispenser can comprise a cap portion adapted to mount over the top portion of the test tube. The bead dispenser can comprise a bead channel defining a bead entry opening and a bead exit opening and a lumen extending from the bead entry opening to the bead exit opening. The diameter of the lumen can be 1 mm to 2 mm larger than the uniform diameter of the beads. The bead channel can extend away from the test tube in a first linear path, can curve, and can extend in a second linear path. The curve can be from 175 degrees to 180 degrees. The curve can be 180 degrees such that the first linear path and the second linear path are parallel. The bead channel can comprise a second curve after the second linear path and before the bead exit opening. The second curve can be from 80 degrees to 90 degrees. The second curve can be 90 degrees such that the bead exit opening is perpendicular to the second linear path. The bead dispenser can be detachable from the test tube. The bead dispenser can be made of a material comprising plastic. The uniform diameter of the beads can be 3.8 mm to 4.2 mm (e.g., 3.8 mm, 3.9 mm, 4.0 mm, or 4.1 mm). The inner diameter of the cap portion can be adapted for a snug fit over the test tube. In some cases, that inner diameter can be about 17 mm to 18 mm (e.g., 18.29 mm) when the outer diameter of the test tube is 18 mm. In some cases, the outer diameter of the cap portion can be 20 mm to 21 mm when the outer diameter of the test tube is 18 mm.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an angled, side view of a bead dispensing device according to some embodiments. Some sections are shown as transparent to view inside components.

FIG. 2 is an opaque, bottom view of a bead dispensing device according to some embodiments.

FIG. 3 is a series of side views of a bead dispensing device according to some embodiments with motions for allowing an operator to dispense a set number of beads.

### DETAILED DESCRIPTION

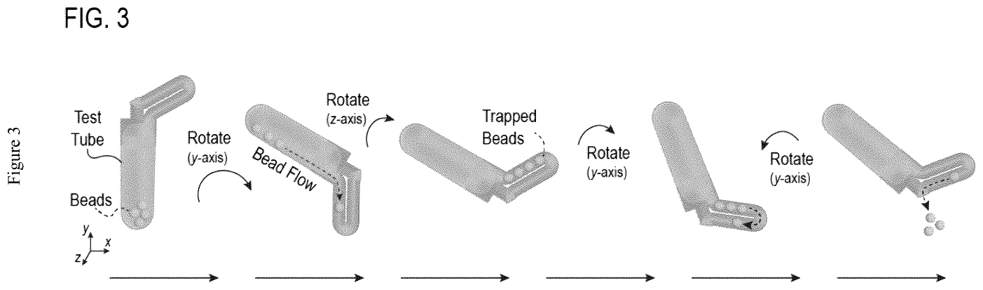

This document provides bead dispensing devices that can be configured to mount onto a container (e.g., a test tube containing sterile beads) and allow for a set number of beads (e.g., glass beads) to be dispensed. For example, a bead dispensing device provided herein can be configured to mount onto the open end of a test tube such as a 13 mm, 16 mm, 18 mm, or 25 mm test tube already containing beads (e.g., glass beads). In some cases, once mounted, the entire apparatus (e.g., bead dispensing device, container, and beads) can be sterilized, thereby providing an operator with the ability to dispense a set number of sterile beads. In operation, the operator can invert the apparatus so that the container aperture (e.g., the test tube aperture) with the mounted bead dispensing device is closest to an agar plate. This motion can move the beads toward the bead dispensing device such that beads enter the bead dispensing device. At this point, the operator can rotate the apparatus to dispense a set number of beads from the bead dispensing device into the agar plate (see, e.g., FIG. 3).

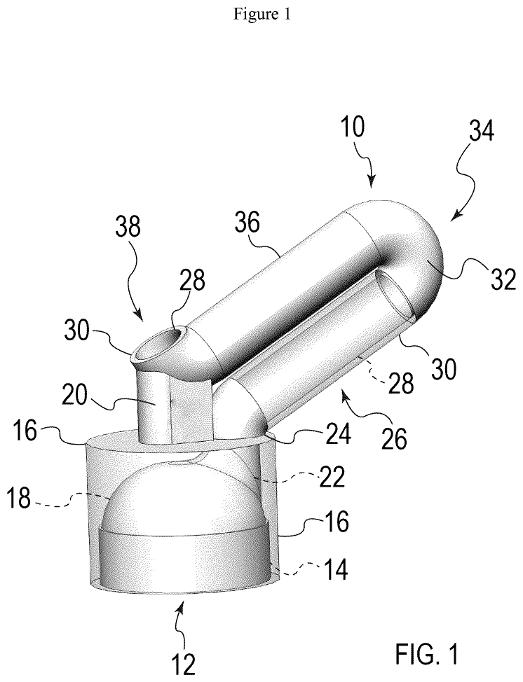

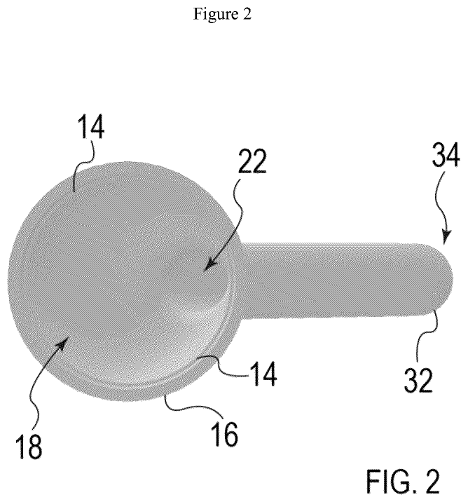

With reference to FIG. 1, bead dispensing device 10 can be designed to attach to a test tube aperture at a cap position 12. The test tube is then enclosed in a slightly larger cylinder 14 with an outer wall 16. In some cases, a space between an inner wall of cylinder 14 and outer wall 16 is not hollow, but the space defined by the inner wall of cylinder 14 can be hollow (see, e.g., FIG. 2).

Once connected to a container (e.g., a test tube), the container and bead dispensing device 10 can be inverted along the y-axis (see, e.g., FIG. 3). This motion can allow beads to funnel from the container (e.g., a test tube) into an inner sphere 18, to an inner connection tube 22, and down a loading tube 26 to a stopping point 32. In some cases, the space between inner sphere 18 and outer wall 16 and between inner connection tube 22 and outer wall 16 can be not hollow. In some cases, loading tube 26 and unloading tube 36 are made up of an inner wall 28 and an outer wall 30. In some cases, the space between inner wall 28 and outer wall 30 is not hollow. In some cases, the exit aperture is supported by support beam 20. In some cases, the support beam 20 is not hollow. In some cases, bead dispensing device 10 can include a connection point 24 that can be at the beginning of loading tube 26. In some cases, the distance from connection point 24 to stopping point 32 determines the number of beads that are dispensed per movement cycle.

After inversion, the appropriate number of beads are loaded into loading tube 26. In some cases, inverting the tube back towards the original upright starting position, but not all the way, can prevent loaded beads from unloading. In some cases, rotating the container and bead dispensing device 10 such that the loading tube, the 180° curve, and the unloading tube 34 are facing upwards can allow the beads to travel through the 180° curve and stopping point 32. At this point, the container and bead dispensing device 10 can be rotated again to allow the beads to exit through the unloading tube 36 and exit aperture 38 and be delivered to an agar plate, thereby providing the agar plate with the set number of beads.

In some cases, a bead dispensing device described herein can be constructed as a single piece using, for example, 3-dimensional printing or plastic molding techniques.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A bead dispenser, wherein said bead dispenser is adapted to mount onto a test tube containing beads of a uniform diameter and dispense a number of said beads from said test tube upon a single upright to inverted and rotated movement of said test tube containing said beads and said bead dispenser, wherein the number of said beads dispensed from each of a plurality of single upright to inverted and rotated movement cycles is the same.

2. The bead dispenser of claim 1, wherein said bead dispenser comprises a cap portion adapted to mount over a top portion of said test tube.

3. The bead dispenser of claim 1, wherein said bead dispenser comprises a bead channel defining a bead entry opening and a bead exit opening and a lumen extending from said bead entry opening to said bead exit opening.

4. The bead dispenser of claim 3, wherein said bead channel extends away from said test tube in a first linear path, curves, and extends in a second linear path.

5. The bead dispenser of claim 4, wherein said first linear path extends away from the test tube at an angle of 60 to 70 degrees.

6. The bead dispenser of claim 4, wherein said curve is 180 degrees such that said first linear path and said second linear path are parallel.

7. The bead dispenser of claim 4, wherein said bead channel comprises a second curve after said second linear path and before said bead exit opening.

8. The bead dispenser of claim 7, wherein said second curve is from 80 degrees to 90 degrees.

9. The bead dispenser of claim 7, wherein said second curve is 90 degrees such that said bead exit opening is perpendicular to said second linear path.

10. The bead dispenser of claim 1, wherein said uniform diameter of said beads is between 3.8 mm and 4.2 mm.

11. A method for dispensing beads from a test tube comprising a plurality of beads of a uniform diameter and a bead dispenser attached to a top of said test tube, wherein said method comprising:
(a) inverting and rotating said test tube over a first target vessel, wherein a first number of said beads is dispensed to said first target vessel, and
(b) inverting and rotating said test tube over a second target vessel, wherein a second number of said beads is dispensed to said second target vessel, wherein said first number and said second number are the same.

12. The method of claim 11, wherein said bead dispenser comprises a cap portion adapted to mount over said top portion of said test tube.

13. The method of claim 11, wherein said bead dispenser comprises a bead channel defining a bead entry opening and a bead exit opening and a lumen extending from said bead entry opening to said bead exit opening.

14. The method of claim 13, wherein said bead channel extends away from said test tube in a first linear path, curves, and extends in a second linear path.

15. The method of claim 14, wherein said first linear path extends away from the test tube at an angle of 60 to 70 degrees.

16. The method of claim 14, wherein said curve is 180 degrees such that said first linear path and said second linear path are parallel.

17. The method of claim 14, wherein said bead channel comprises a second curve after said second linear path and before said bead exit opening.

18. The method of claim 17, wherein said second curve is from 80 degrees to 90 degrees.

19. The method of claim 17, wherein said second curve is 90 degrees such that said bead exit opening is perpendicular to said second linear path.

20. The method of claim 11, wherein said uniform diameter of said beads is between 3.8 mm and 4.2 mm.
